(19) United States
(12) Patent Application Publication
(10) Pub. No.: US 2010/0328368 A1
(43) Pub. Date: Dec. 30, 2010

(54) THREE DIMENSIONAL DISPLAY SYSTEM AND ITS DISPLAY CONTROL METHOD

(76) Inventor: Shuwen CHEN, (US)

Correspondence Address: Hasse & Nesbitt LLC, 8837 Chapel Square Drive, Suite C, CINCINNATI, OH, 45249, US

(21) Appl. No.: 12/874,720

(22) Filed: Sep. 2, 2010

(30) Foreign Application Priority Data
Mar. 3, 2008 (CN) CN200810026565.1
Mar. 3, 2009 (CN) PCT/CN2009/070611

(51) Int. Cl. G09G 5/10

(52) U.S. Cl. 345/690

(57) ABSTRACT

A 3-D display system and relevant display control method, consisting of linear display units vertically arranged in a 2-D plane or cylindrical columns to form a 3-D display matrix, and a display control system that acquires corresponding display data through computer image processing and outputs the display data to control units. The control units issue control signals to the illuminants with corresponding addresses at corresponding time instants, to light up the corresponding illuminants and make the 3-D display matrix display a corresponding 3-D image or animation. The illuminants can be monochromatic or multicolor LEDs or other point light sources.

### CROSS REFERENCE TO RELATED APPLICATIONS

This application claims the benefit of International Application PCT/CN2009/070611, with an international filing date of Mar. 3, 2009, which claimed the benefit of Chinese Application No. CN200810026565.1, filed Mar. 3, 2008, the disclosures of which are incorporated herein by reference.

### TECHNICAL FIELD

The present invention relates to a display device and its display control method, particularly a display matrix for decoration or exhibition purposes and capable of displaying 3-D images, and the display control method for the matrix.

### BACKGROUND ART

Lighting decorations and outdoor display panels have been widely used heretofore. They are mainly used for decorations in holidays and for advertisement exhibitions. Current products mainly use flat panels, and relevant control techniques are mature. However, they can only display 2-D images. With the development of display technology, 3-D display techniques have evolved into preliminary forms. These 3-D techniques mainly include the following forms. The first one is respectively projecting different images onto left and right eyes of a person to virtualize a stereo-image. This technique can utilize current 2-D display techniques. A viewer needs to wear tailor-made glasses or display device in this situation and the display quality is good. However, this technique is only suitable for displays in relation to, for example, movies or TV shows. It can not be used for outdoor exhibition. The second one is using 3-D projection. However, this technique requires rather sophisticated and expensive apparatuses. Meanwhile, it is still under experiment and can not meet practical requirements. Also, it can not be used for outdoor exhibition. The third one is using point lights to build up a 3-D display matrix in space and lighting up corresponding point lights to form a corresponding pattern or animation. Though the display quality this technique can bring about is relatively low compared with the above-mentioned two techniques, it is easy to implement and inexpensive, and is particularly suitable for decoration or outdoor advertisement exhibition. For the third 3-D display technique, the key is to build up a 3-D display matrix. In prior arts such as China patent “3-D visual display method and apparatus”, with application no. 200610101245.9 and publication date Aug. 8, 2007, the disclosure of which is incorporated herein by reference herein in its entirety, it is necessary to build up a matrix composed of many cubic units, each node of which connects to a display unit. The structure of the matrix is quite complex and usually it is made manually. Since the manufacturing process for this kind of matrix is very cumbersome and complex, it is hard to build up large matrix. Therefore, this kind of matrixes can not be mass produced and their production costs are rather high. In addition, it is not possible to disassemble and store these matrixes after their installation. Thus, these matrixes are not convenient to use.

### SUMMARY OF THE INVENTION

One aspect of the present invention is to provide a 3-D display system. It uses modular display units, can be mass produced, is easy to install, and can be disassembled for ease of storage and transportation.

Another aspect of the present invention is to provide a method for controlling aforesaid 3-D display system. It can perform data processing on displayed contents and then control the display of the 3-D display matrix. It is easy to use and more reliable.

In the present invention, the above-mentioned aspects are realized in the following manner.

A 3-D display system comprises linear display units and control units for controlling the linear display units, wherein a linear display unit comprises a conductor and illuminants evenly distributed along the conductor and electrically connected to the conductor. A plurality of said linear display units are vertically arranged in a 2-D plane to form a 3-D display matrix. The linear display units are respectively connected to corresponding ports of the control units. The control units outputs control signals to light up corresponding illuminants in the 3-D display matrix such that the 3-D display matrix display a corresponding 3-D image or animation.

A display control method for a 3-D display system acquires corresponding display data via computer image processing. Said display data comprise address parameters, display parameters and time parameters. The display parameters are input to a control unit. The control unit stores addresses each of which uniquely corresponds to a corresponding illuminant. At a corresponding time instant, the control units issue control signals to illuminants associated with corresponding addresses and light up the corresponding illuminants, such that the 3-D display matrix displays a corresponding 3-D image or animation.

The positive effects of this invention is, arranging the linear display units according to certain rules and a desired 3-D display matrix can be formed. Then, the display units can be connected to corresponding output units of the control unit. The installation is easy, and the system can be flexibly expanded to form larger display matrix. Since the above-mentioned linear display units can be mass produced, the production costs thereof are low, and these display units can be used for a wide range of applications. For example, they can be used in hotel lobbies, pubs, night clubs, entertainment venues or stages and produce a weird and overwhelming atmosphere of stereo-lights; they can be used as dynamic 3-D display models for teaching, research and presentation purposes, achieving vivid visual effects; they can also be used in billboards, lighting decorations nearby streets, interior decorations and aisle passages. For ease of controlling the 3-D display matrix and processing the displayed images or animations, the present invention utilizes corresponding control method and simplifies the design and control method, which makes it more reliable to use.

### BRIEF DESCRIPTION OF THE DRAWINGS

In the following, the present invention will be further described through embodiments and with reference to the accompanying drawings.

FIG. 1 is a stereogram of the first 3-D display matrix embodiment of the present invention.

FIG. 2 is a partial enlarged view of portion A in FIG. 1.

FIG. 3 is a partial enlarged view of the bottom portion of linear display unit 1 in the first embodiment.

FIG. 4 is a stereogram of the second 3-D display matrix embodiment of the present invention.

FIG. 5 is a stereogram of the third 3-D display matrix embodiment of the present invention.

FIG. 6 is a partial enlarged view of portion B in FIG. 5.

FIG. 7 is a stereogram of the fourth 3-D display matrix embodiment of the present invention.

FIG. 8 is a stereogram of the fifth 3-D display matrix embodiment of the present invention.

FIG. 9 is a functional block diagram of the first control unit embodiment of the present invention.

FIG. 10 is a functional block diagram of the second control unit embodiment of the present invention.

FIG. 11 is a functional block diagram of the third control unit embodiment of the present invention.

FIG. 12 is a functional block diagram of the fourth control unit embodiment of the present invention.

FIG. 13 is a functional block diagram of the fifth control unit embodiment of the present invention.

FIGS. 14-1A and 14-1B are an electric scheme diagram for the drive circuit in the fifth control unit embodiment of the present invention.

FIG. 14-2A is an electric scheme diagram for the primary control circuit shown in FIG. 14-2B and the gating circuit shown in FIG. 14-2C, in the fifth control unit embodiment of the present invention.

FIG. 14-3 is an electric scheme diagram for the multiple sets of illuminants in the fifth control unit embodiment of the present invention.

### DETAILED DESCRIPTION OF THE EMBODIMENTS

A 3-D display system comprises linear display units 1 and a control unit 2. A linear display unit 1 comprises a conductor 11 and illuminants 12 evenly distributed along and electrically connected to the conductor 11. A plurality of the linear display units are vertically arranged in a 2-D plane to form a 3-D display matrix. The linear display units are electrically connected to corresponding control units 2. The control units 2 output signals to light up corresponding illuminants 12 in the 3-D display matrix, such that the matrix display a corresponding 3-D image or animation. In order to prevent conductors 11 in the display system or connectors from blocking illuminants 12 and degrading the display performance, the display units 1 take the form of a line, which blocks less of the illuminants 12 on the display unit 1 than other configurations do. Meanwhile, since the display system is often distantly spaced from the viewer, this kind of configuration will not affect the overall display performance. Elongated print circuit board can be used in this application. The illuminants 12 are welded to the circuit board to form linear display units 1. Alternatively, linear display units 1 in the form of light bunch can be used. Then, arrange these linear display units according to certain rules to form a desired 3-D display matrix. Thereafter, connect these display units to corresponding output units of the control units 2. The installation of this system is easy, and the system can be flexibly expanded to form larger display matrix. Since the components can be mass produced, the production costs thereof are low, and these display units can be used for a wide range of applications. For example, they can be used in hotel lobbies, pubs, night clubs, entertainment venues or stages and produce a weird and overwhelming atmosphere of stereo-lights; they can be used as dynamic 3-D display models for teaching, research and presentation purposes, achieving vivid visual effects; they can also be used in billboards, lighting decorations nearby streets, interior decorations and aisle passages.

Since each set of illuminants 12 need to connect corresponding control signal lines from the control units 2, if the 3-D display matrix is not very large, then the control units 2 can be integrated into a single chip or a computer can be directly used as the control unit 2. However, in this configuration there are numerous and complex connections of the control signal lines, which not only makes the wiring difficult and prone to errors, but also affects the stability of the system. To simplify the connections of these control signal lines, each of the control units 2 comprises a primary control circuit 21 and a drive circuit 22. The primary control circuit 21 is mainly used to store and process the display data and coordinate the display of the whole 3-D display matrix. The drive circuit 22 is mainly used to receive the control signals from the primary control circuit 21 and decode the control signals and light up a corresponding illuminant 12. Therefore, the drive circuit 22 can be provided on the wiring end of each display unit 1 or each illuminant 12 is configured to have its own drive circuit 22, where serial communication can be used between the drive circuit 22 and the primary control circuit 21. This can effectively reduce the number of the connections, make the wiring of the whole system more succinct, improve the stability of the system and make the system easier to install.

According to actual needs, there may be multiple designs and installation modes for the 3-D display matrix.

### Embodiment 1 of the 3-D Display Matrix

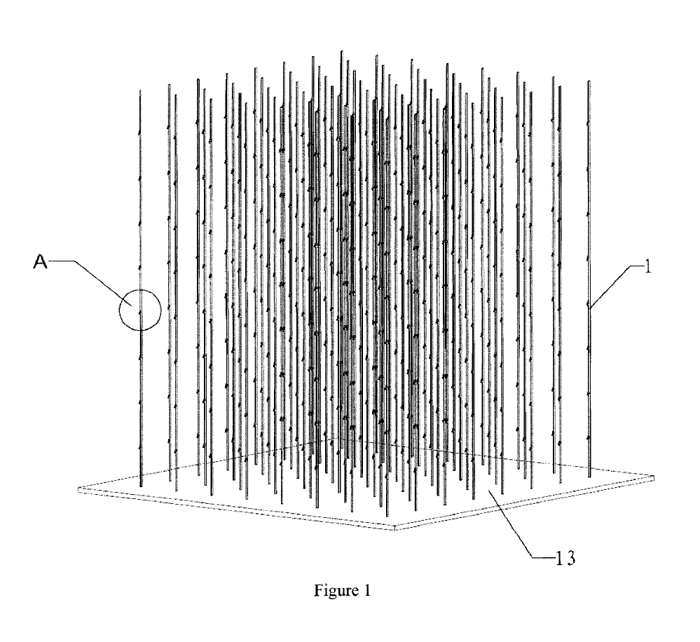

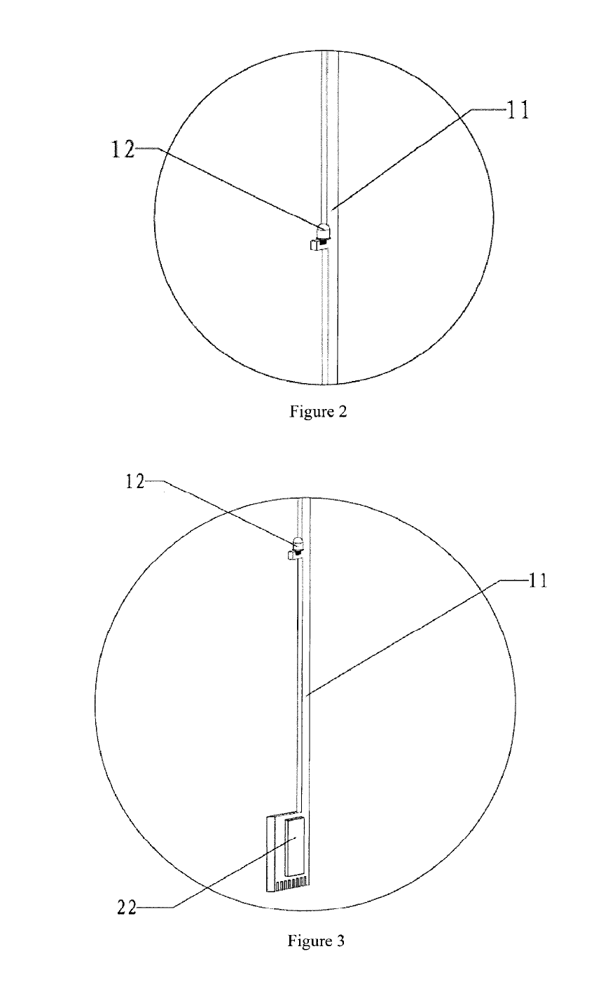

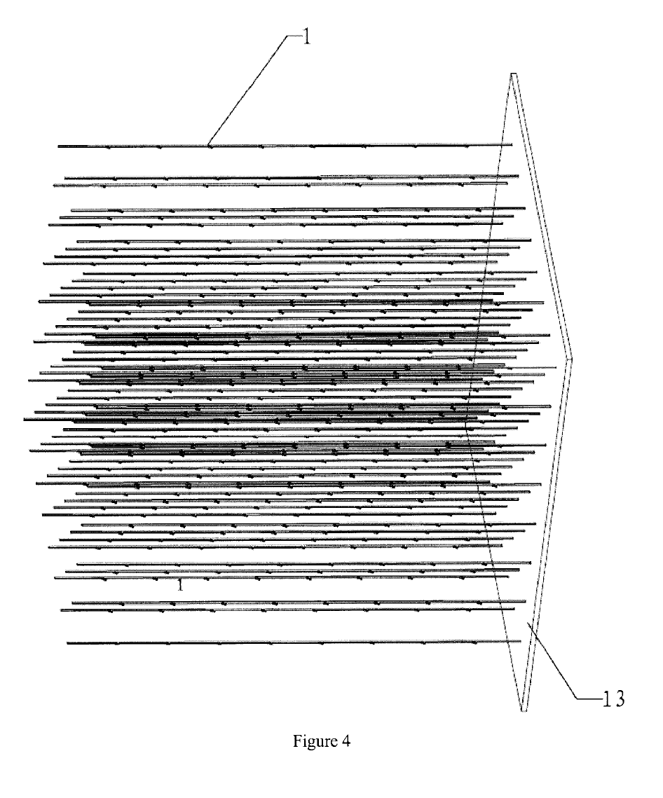

Refer to FIG. 1 to FIG. 3, conductor 11 of a linear display unit 1 is made from a elongated print circuit board, on which a plurality of illuminants 12 are welded in certain intervals. Meanwhile, a drive circuit 22 for driving said set of illuminants 12 is installed on the print circuit board. A base 13 is also provided, on which a plurality of sockets are regularly provided, whereas matching pins are provided on the bottom of the print circuit board. At the same time, according to actual needs the primary control circuit can be placed inside base 13. When performing the assembling, the 3-D display matrix can be formed by inserting the linear display units 1 onto bases 13. This process is easy and fast. In addition, assembling and disassembling the matrix is also convenient. The 3-D display matrix with aforesaid structure is suitable for horizontal disposition. It can also be fixed onto a vertical plane, as shown in FIG. 4 (embodiment 2).

### Embodiment 3 of the 3-D Display Matrix

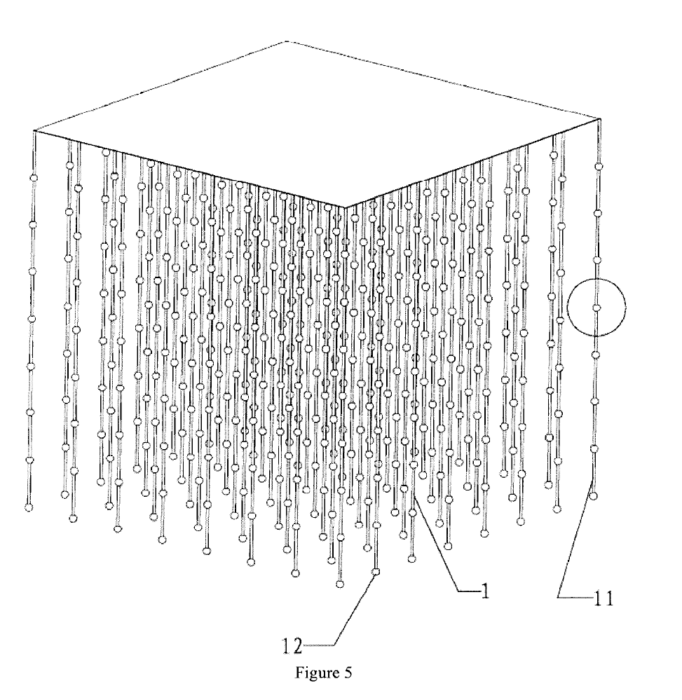

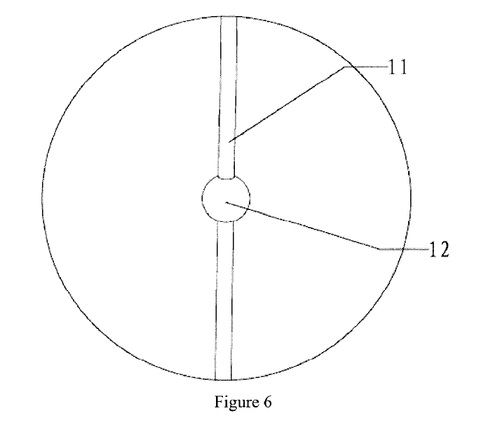

Refer to FIGS. 5 and 6, wire 11 of a linear display unit 1 is made from soft wire. It can be a wire with certain stiffness, or a wire fiber along which a wire bundle is disposed. The illuminants 12 are serially connected in certain intervals on wire 11, forming a bunch of lights. The drive circuits 22 can be provided on the end of the wire 11, or they can be integrated into the illuminants 12. Hanging multiple aforesaid bunches of lights from the roof or a fixed bracket forms a 3-D display matrix.

### Embodiment 4 of the 3-D Display Matrix

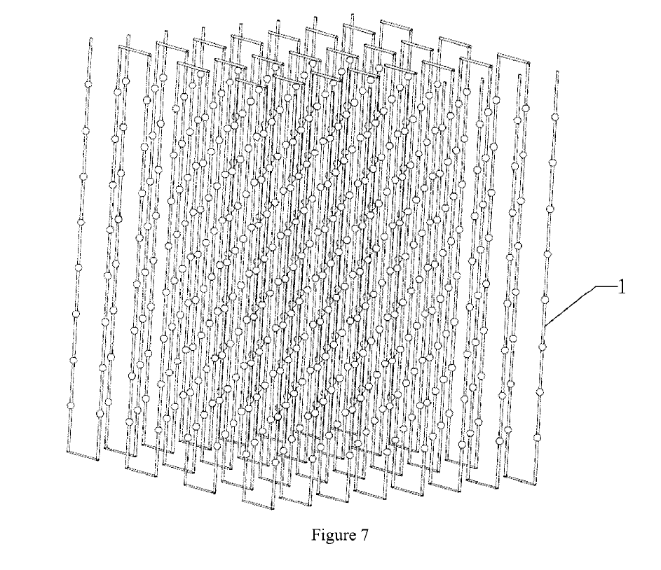

Refer to FIG. 7, elongated print circuit board with illuminants 12 welded thereon or bunch of lights can be used for the structure of linear display unit 1. Then, these linear display units are serially connect to form a display plane. After arranging these display planes towards an orientation, a 3-D display matrix is formed.

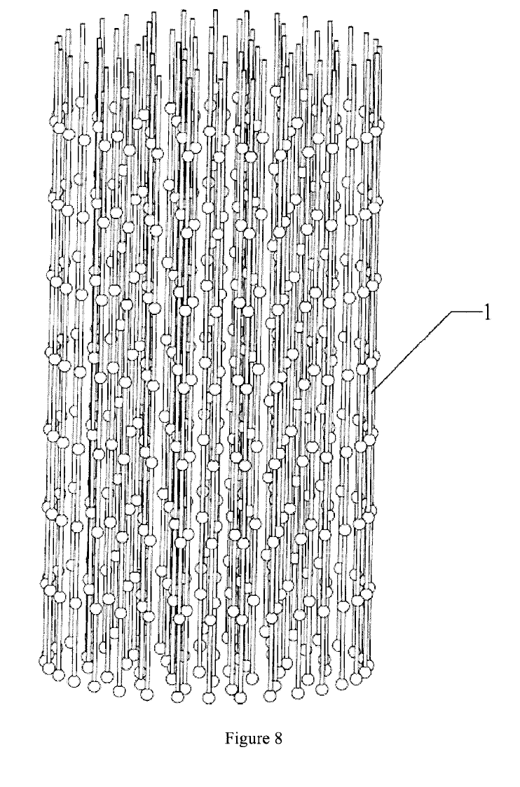

Of course, according to actual needs, the matrix can be arranged into a cuboid-like 3-D display matrix using relevant Cartier coordinates, or can be arranged into a columnar 3-D display matrix (see FIG. 8) using relevant cylindrical coordinates, etc.

As far as illuminants 12 are concerned, the present invention can achieve monochrome, multicolor or even full color effects. Therefore, monochromatic illuminants 12 or illuminants 12 made up of red, green and blue(three-primary colors) light emitting units can be selected. According to current large scale flat panel display techniques, the aforesaid light emitting units basically make use of LEDs, because LEDs have the advantages of low power consumption, long life span, high light emitting efficiency, extremely short response time, and encapsulations of LEDs are particularly suitable for various outdoor harsh environments. Therefore, LED is a preferred choice for light emitting units in the 3-D display matrix. Of course, other forms of point light sources can be selected. In this situation, the drive circuit 22 needs to be modified.

A detailed description of corresponding control unit 2 will be provided in the following in connection with relevant electrical scheme diagrams.

### The First and Second Control Unit Embodiments

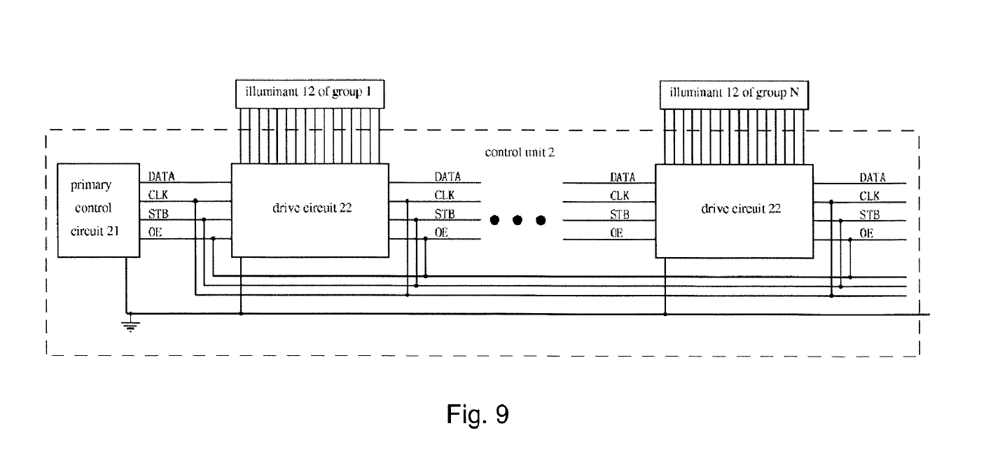

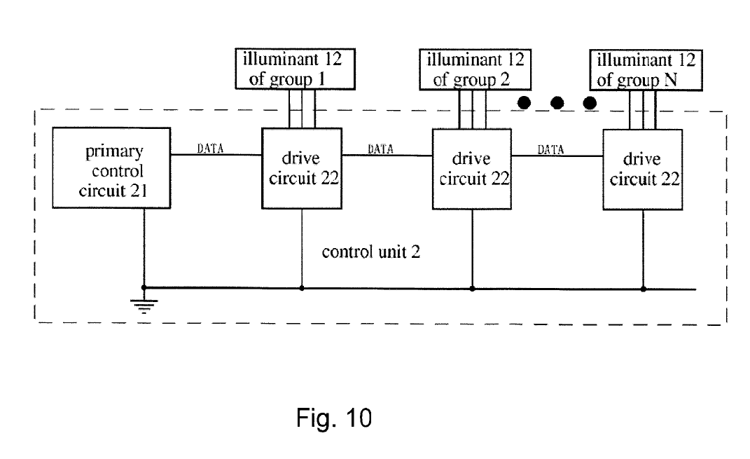

Refer to FIGS. 9 and 10. The control unit 2 consists of a primary control circuit 21 and a drive circuit 22. The primary control circuit 21 can be a computer or a customary single-chip microcomputer. A serial shift register is used as the drive circuit. The reason for this configuration is, if a serial communication is established between the primary control circuit 21 and the drive circuit 22, the wiring will be greatly simplified and the output of the primary control circuit 21 only needs to output several corresponding data and control signals, such as data signal DATA, clock signal CLK, latch signal STB and enable signal OE, etc. The drive circuit 22 has multiple outputs connected to corresponding light emitting units. When the drive circuit 22 receives the data and control signals from the primary control circuit 21, it decodes these signals and output signals at corresponding outputs to light up corresponding light emitting units, such that the 3-D display matrix displays a corresponding 3-D image or animation. The aforesaid control unit 2 can drive monochromatic or colored light emitting units. If a monochromatic display is desired, it only needs to connect the monochromatic LEDs to the outputs of the drive circuit 22. If a colorful display is desired, each illuminant 12 needs to be made up of red, green and blue LEDs, and the outputs of the drive circuit 22 are respectively repetitively connected to the three kinds of colored LEDs. The difference between the first embodiment and the second embodiment lies in that the circuit structure of the first embodiment is suitable for the situation where there are not too many (usually 16) illuminants on the linear display unit 1. In this situation, connections of light emitting units in all illuminants 12 are consolidated in a single drive circuit 22. However, if there are many illuminants 12, the number of the connections will also be huge, and the circuit structure of the first embodiment will not be suitable. In this situation, the circuit structure of the first embodiment may be used. This equals to integrating a drive circuit 22 into each illuminant 12 and the drive circuits of the illuminants 12 being serially connected. Though this increases the number of the drive circuits 22, the structures of the drive circuits 22 will be simplified and they are relatively inexpensive. In the meantime, connection wires will be greatly reduced. This simplifies the structure and is suitable for the application.

### The Third Control Unit Embodiment

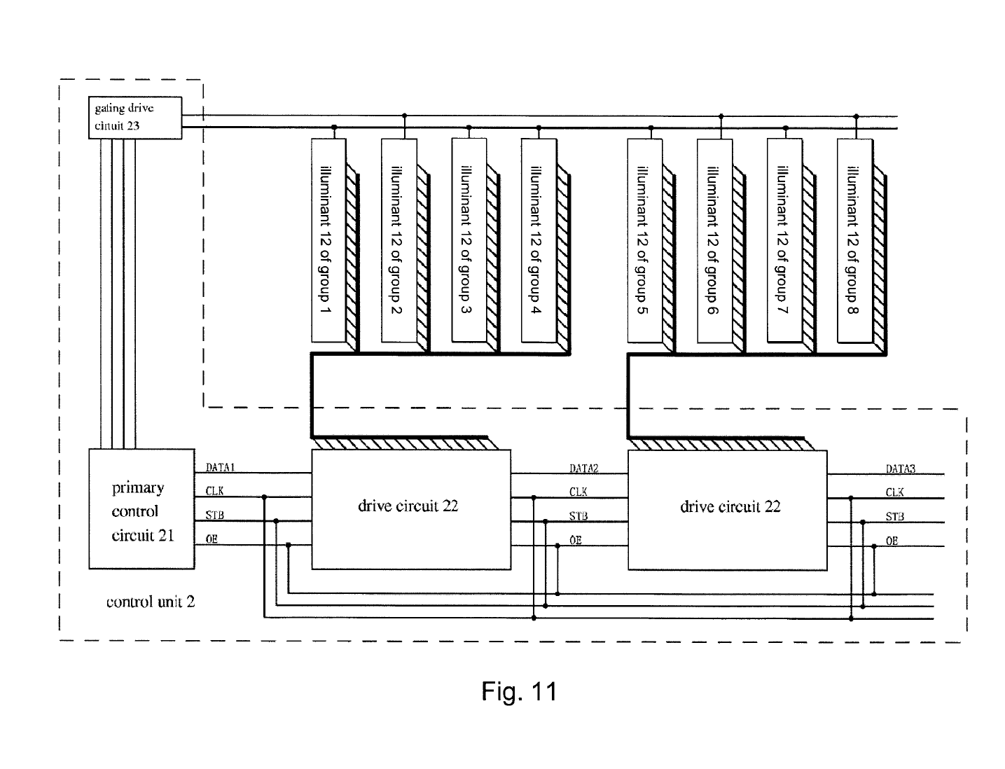

Refer to FIG. 11. It is a block diagram for a control unit 2 to utilize one half time division technique for controlling red, green and blue LEDs. So-called time division technique is dividing the display cycle of each illuminant into multiple sub-cycles in accordance with certain ratios. The red, green and blue parts in the three-color light emitting units are respectively lighted up in each sub-cycle, and various colors will be displayed by mixing the colors of the three-primary-color light emitting units, thus the object of displaying colorful image will be attained. This technique can greatly reduce the number of the drive circuits 22 to be used in the first control unit embodiment and effectively reduce the production costs. The plurality of illuminants 12 on each linear display unit 1 are classified into one or more groups. Usually, each group comprises 16 light emitting units, including red, green and blue light emitting units. An electrode of each light emitting unit is connected to a corresponding drive port of the drive circuit 22. The other electrodes of all light emitting units in the same group are on a common line, and the primary control circuit of the control unit 2 is equipped with two gating outputs for alternate connection with different groups of light emitting units. The gating outputs are used for gating one or more certain groups of light emitting units. Then, the drive circuit 22 selects different colors. By mixing the colors of the three-primary-color LEDs, various colors can be displayed and the object of displaying colorful images can be attained.

Additionally, since the drive power for the outputs of the primary control circuit 21 is relatively low, if the display matrix is large and there are many illuminants 12, directly using the outputs of the primary control circuit 21 as the gating outputs can not satisfy the needs. Therefore, a gating drive circuit is added, and the gating outputs of the primary control circuit 21 are serially connected to the gating drive circuit 23 and then connected to the illuminants 12. The basic function of the gating drive circuit 23 is equivalent to a electronic switch, it can be made from a high power transistor or a switch integrated circuit, the input of which receives the signals from the gating outputs of the primary control circuit 21 to control the electronic switch and realize the on and off states of the switch.

### The Fourth Control Unit Embodiment

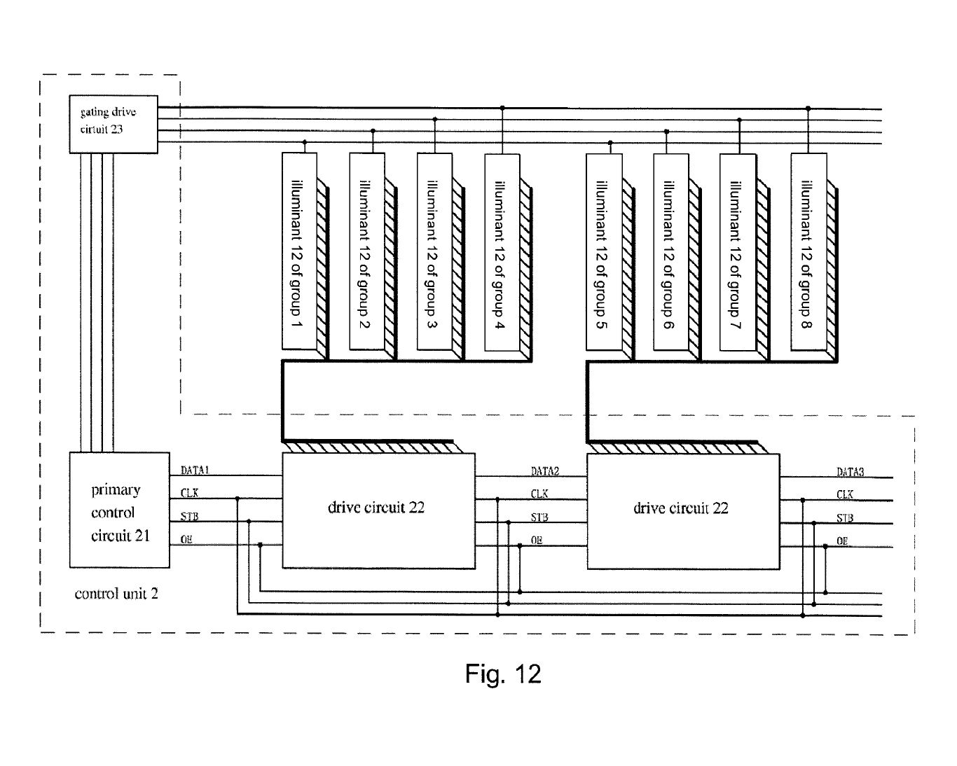

Refer to FIG. 12. It is a block diagram for control unit 2 to utilize one fourth time division technique for controlling red, green and blue LEDs. That is, this technique divides the display cycle of a illuminant into four sub-cycles. In this embodiment, the basic structure of the control unit 2 is similar to that of the control unit 2 in the third control unit embodiment. The difference between these two kinds of control units lies in that the primary control circuit 21 in this embodiment has four gating outputs, which alternately connect to the collinear electrodes in the different groups of the light emitting units. Of course, one eighth or one sixteenth time division control units can be made following the above mentioned principles.

However, since the colorful display is usually realized by using three-primary-color LEDs, whereas the number of the sub-cycles of above-mentioned time division techniques are not multiples of three, it is not possible to only select one certain color for display. Meanwhile, this makes the wiring of the whole 3-D display matrix very complicated and makes the control method rather cumbersome. That is, the design of the control program will become very complex.

### The Fifth Control Unit Embodiment

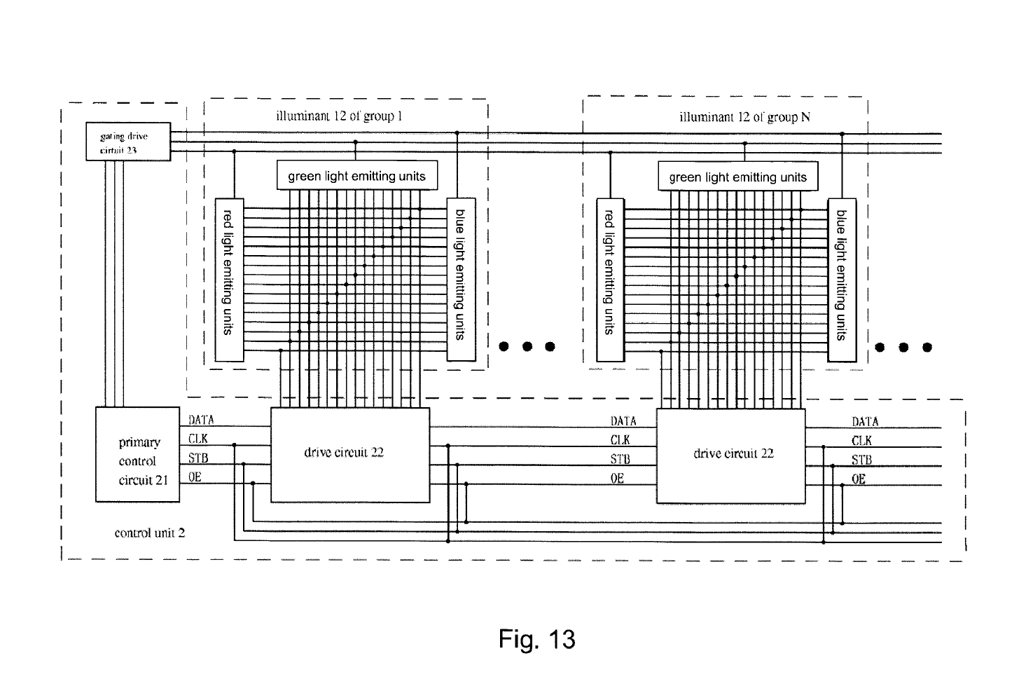

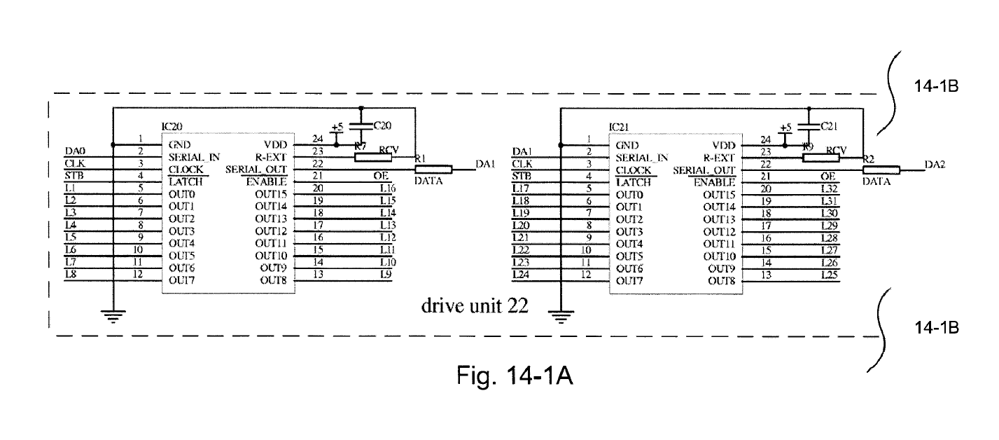

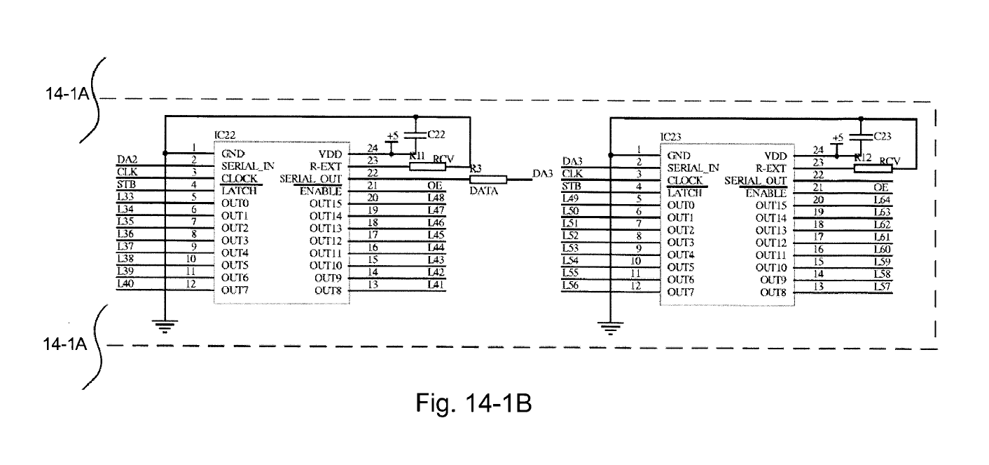

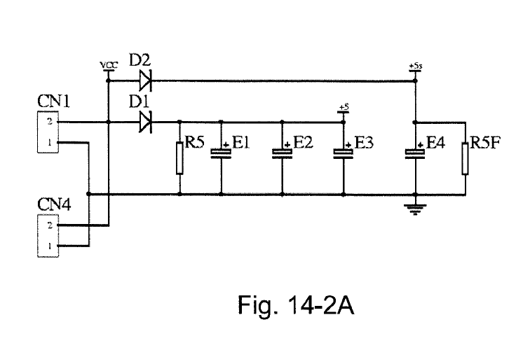

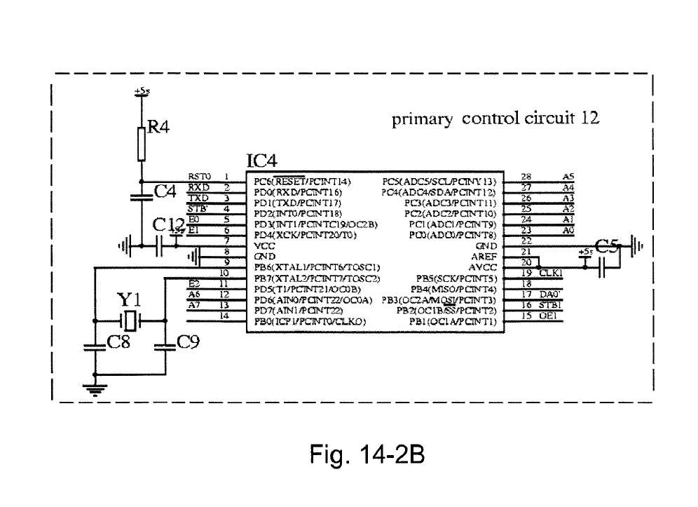

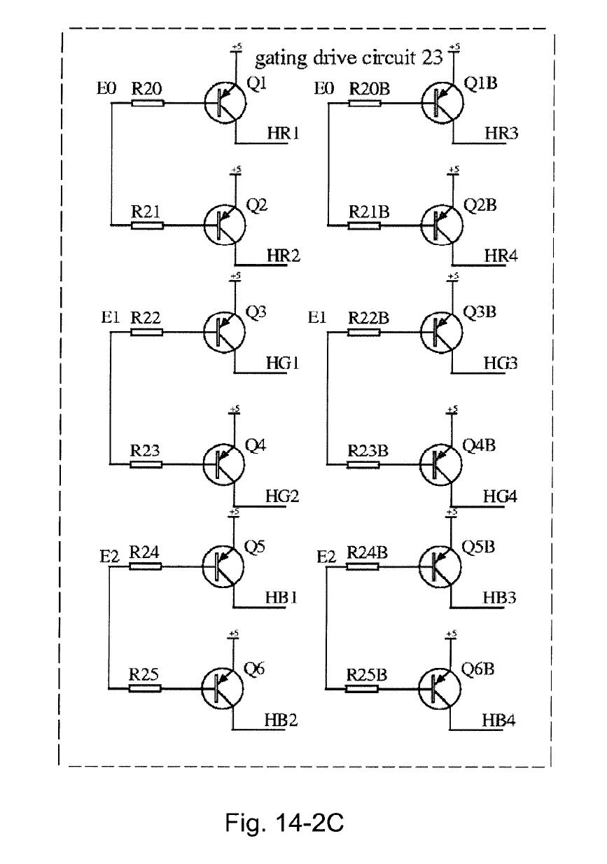

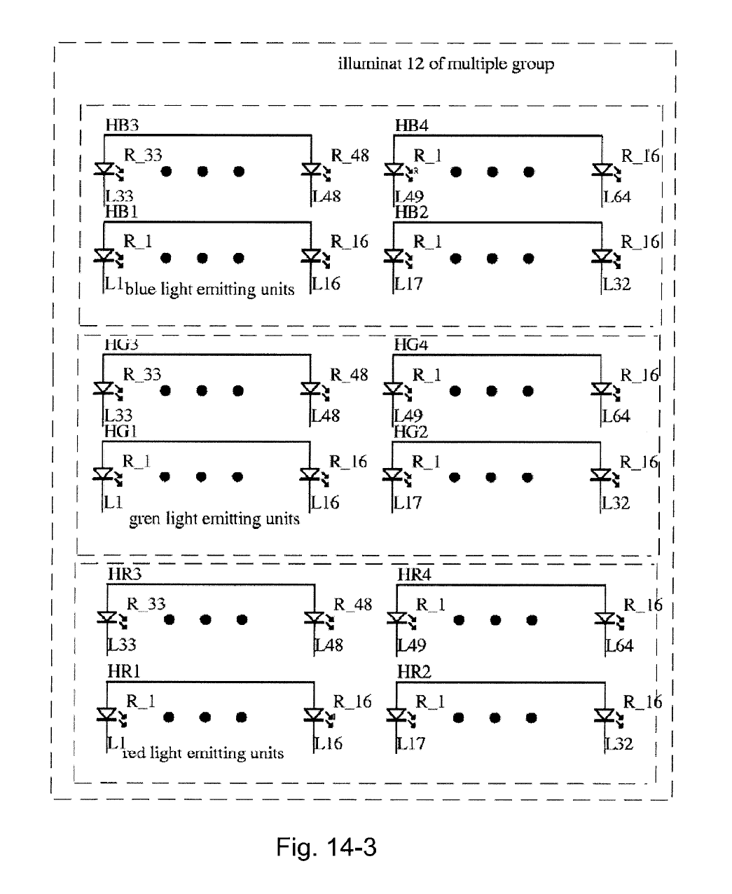

Refer to FIGS. 13 and 14 (including FIGS. 14-1A, 14-1B, 14-2A, 14-2B, 14-2C, and 14-3). They are block diagram and electric scheme diagrams for control unit 2 to utilize one third time division technique for controlling red, green and blue LEDs. Likewise, the light emitting units of a plurality of illuminants 12 on each linear display unit 1 are classified into one or more groups. In each illuminant 12, one electrode from red light emitting units, one electrode from green light emitting units and one electrode from blue light emitting units are made to be collinear and then are connected to drive outputs of a drive circuit 22. Other electrodes of the same colored light emitting units in each group of illuminants are made to be collinear and then are respectively connected to gating outputs of corresponding colors in the primary control circuit 21. The number of the gating outputs for each color can be N. That is, the total number of these gating outputs can be 3N, wherein N can be 1, 2, 3, etc. The drive port is used for selecting the illuminants 12 to be driven, whereas the gating outputs are used for gating the color needed to be displayed by the illuminant 12.

In order to control aforesaid 3-D display matrix, a corresponding control method is provided.

First, it is necessary to acquire display data. The display data usually comprises address parameters, display parameters and time parameters. The address parameter records the location of a certain illuminant 12 in the 3-D display matrix. Generally speaking, different expressions, such as Cartier coordinates, cylindrical coordinates, etc, can be used according to different structures of the matrix. The display parameter generally includes luminance value of each unit in an illuminant 12. The time parameter denotes the status of the illuminant at a certain time instant.

According to prior arts, the display data can be obtained by acquisition or design. For example, if the 3-D display matrix needs to display dynamic frequency spectrums according to the rhythm and frequency of the music, then music data can be sampled and processed by computer to form corresponding display data. Directly plotting desired picture in a computer by resorting to computer image processing is also possible. Then the display data can be obtained through calculations by calling corresponding programs. Thereafter, the display data is input to the control unit 2 via data transmission. In the control unit, each illuminant 12 has its unique address. The control unit 2 issues control signals to illuminants with corresponding addresses at corresponding time instants and lights up the corresponding illuminants 12, such that the 3-D display matrix displays a corresponding image or animation.

As to the address parameters, the present invention preferably uses Cartier coordinates, to facilitate the calculation and control of the primary control circuit 21. The address parameter can be expressed as (X, Y, Z). For display parameters, if monochromatic LEDs are used, then it is sufficient to set the display parameters as luminance values(usually they can be in the range of levels 0 to 255). If red, green and blue LEDs are used as the light emitting units, then the display parameters include color parameters for controlling the red, green and blue light emitting units in the illuminants 12. RGB or other relevant parameters denoting the colors can be used. Taking the fact that the light emitting units using red, green and blue into account, the present invention preferably uses RGB parameters as the display parameters. The luminance values for each color are all within the range of 0 to 255. Then, a full color display can be achieved. It is thus clear from the above that a serial communication is established between the primary control circuit 21 and the drive circuit 22. This can effectively reduce the wiring. Clearly, for control units having different structures, the control processes will be different.

The control process for the first and second control unit embodiments is as follows. The primary control circuit 21 converts the time parameters in the display parameters into control sequences, and transmits the address parameters and the display parameters to the drive circuit 22 using certain serial communication data format. Each drive circuit 22 determines whether to accept the data according to the address parameters, decodes and converts the accepted data to control electrical levels of the corresponding outputs, and turns on or turns off light emitting units in the corresponding illuminants 12. For colorful display, it is also necessary to adjust the luminance values of the red, green and blue light emitting units to mix the lights to form different colors and luminosities.

The control process for the third and fourth control unit embodiments is as follows. The primary control circuit 21 converts the time parameters in the display parameters into control sequences, and transmits the address parameters and the display parameters to the drive circuit 22 using certain serial communication data format. The gating outputs gate one or more groups of illuminants 12 that need to be lighted up. Then, according to the address parameters and the display parameters, the serial port issues control signals to the drive circuit 22 to select the colors that needs to be lighted up in each group of illuminants 12.

The control process for the fifth control unit embodiments is as follows. The primary control circuit 21 converts the time parameters in the display parameters into control sequences, and transmits the address parameters and the display parameters to the drive circuit 22 using certain serial communication data format. Each drive circuit 22 determines whether to accept the data according to the address parameters, decodes and converts the accepted data into parallel outputs to drive corresponding illuminants 12. Meanwhile, according to the display parameters, the gating ports output corresponding electrical levels to control the colors that need to be displayed by each group of illuminants 12. As such, with the coordination of the drive circuit 22 and the gating ports, the color and luminance of each illuminant in the 3-D display matrix can be controlled, which makes the 3-D display matrix display a colorful 3-D image or animation.

1. A 3-D display system, comprising linear display units and control units for controlling the linear display units, wherein a linear display unit includes a conductor and illuminants distributed evenly along and electrically connected to the conductor; a plurality of linear display units being arranged vertically in a 2-D plane to form a 3-D display system; the linear display units being respectively connected to corresponding ports of the control units; the control units outputting control signals to light up corresponding illuminants in the 3-D display matrix, such that the 3-D display matrix display a corresponding 3-D image or animation.

2. The 3-D display system according to claim 1, wherein said control units includes primary control circuits and drive circuits, the drive circuits being connected to corresponding outputs of the primary control circuits, and the outputs of the drive circuits being connected to the illuminants.

3. The 3-D display system according to claim 2, wherein the primary control circuits are provided with gating outputs connected to the illuminants.

4. The 3-D display system according to claim 3, further including a gating drive circuit, wherein the gating outputs of the primary control circuit serially connect to the gating drive circuit and connect to the illuminants.

5. The 3-D display system according to claim 1, wherein the light emitting units are made up of red, green and blue light emitting units, and the two electrodes of each light emitting units are respectively connected to corresponding outputs of the control units.

6. The 3-D display system according to claim 2, wherein the light emitting units are made up of red, green and blue light emitting units, and the two electrodes of each light emitting units are respectively connected to corresponding outputs of the control units.

7. The 3-D display system according to claim 3, wherein the light emitting units are made up of red, green and blue light emitting units, and the two electrodes of each light emitting units arc respectively connected to corresponding outputs of the control units.

8. The 3-D display system according to claim 4, wherein the light emitting units are made up of red, green and blue light emitting units, and the two electrodes of each light emitting units are respectively connected to corresponding outputs of the control units.

9. The display control method for the 3-D display matrix of claim 1, wherein the display data is obtained by computer acquisition or image processing, the display data includes address parameters, display parameters and time parameters, the display data is input to the control units, each illuminants has a unique corresponding address in the control units, the control units issues control signals to illuminants with corresponding addresses in accordance with the display data, to light up corresponding illuminants, and make the 3-D display matrix display a corresponding 3-D image or animation.

10. The display control method for the 3-D display matrix according to claim 9, wherein the display parameters comprise color parameters for controlling the red, green and blue three-primary-color light emitting units in the illuminants.

11. A display control method for the 3-D display matrix according to claim 9, characterized in that said control units are consist of primary control circuits (421) and drive circuits (422), the primary control circuits transmit control signals to the drive circuits (422) via serial communication, the drive circuits (22) receive and decode corresponding control signals in accordance with address information, and control corresponding illuminants (12).
